(19) United States
(12) Patent Application Publication
(10) Pub. No.: US 2011/0004858 A1
(43) Pub. Date: Jan. 6, 2011

(54) METHOD FOR CONCURRENT MIGRATION AND DECOMPOSITION OF INTEGRATED CIRCUIT LAYOUT

(75) Inventors: Yao-Wen Chang, Taipei (TW); Chin-Hsiung Hsu, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/550,484

(22) Filed: Aug. 31, 2009

(30) Foreign Application Priority Data
Jul. 2, 2009 (TW) 098122379

(51) Int. Cl. G06F 17/50

(52) U.S. Cl. 716/122; 716/139

(57) ABSTRACT

A method for concurrent migration and decomposition of an integrated circuit layout applicable to double patterning lithography techniques is provided. The method includes cutting a sub-pattern of an initial pattern to configure a potentially conflicting pattern having separate or cutting sections; removing odd cycles in the potential conflicting pattern so as to cut the separate or cutting sections; configuring the double patterning constraint based upon corresponding location relations between each and adjacent cut sections; and assigning a first color layer or a second color layer to the cut sections according to the double patterning constraint to obtain a final layout pattern. Therefore, disadvantageous factors and patterning conflicts caused by separate processes as encountered in the prior art are avoided.

### BACKGROUND OF THE INVENTION

1. Field of the Invention

This invention relates to integrated circuit layout migration and layout decomposition methods, and more particularly, to a method for concurrent migration and decomposition of integrated circuit layout, which is applicable to a double patterning technology for currently migrating and decomposing layout patterns of an integrated circuit.

2. Description of Related Art

As the integrated circuit manufacturing process is advanced from deep submicron meter level into nano meter level, a double patterning technology (DPT) and a layout migration technology are two closely related issues for the integrated circuit manufacturing process. The double patterning technology enables layout patterns on a mask set to be decomposed and mapped to two mask sets, and uses a double exposure patterning technology to increase the cell pitch of any one of the mask sets, so as to improve the printability. The layout migration technology migrates or transfers layout patterns that conform with the conventional integrated circuit manufacturing process to a more advanced integrated circuit, and tries to reduce the differences generated before and after the layout migration.

Please refer to FIGS. 1A and 1B, which show new layout patterns generated from an initial layout pattern via layout migration and layout decomposition steps in different orders, and the impacts on the initial layout pattern by each of the steps. As shown in FIG. 1A, sub-patterns 100 in the initial layout pattern L1 have their pitches be adjusted via the layout migration step S1, and a layout pattern L1′ that better conform with a new manufacturing process is thus generated. Since the new manufacturing process may demand more strict cell size or cell pitch, the layout migration step S1 may result in the difference between the layout patterns L1 and L1′, e.g., different-sized pitches between the sub-patterns. Then, each of the sub-patterns of the layout pattern L1′ on a single mask set is decomposed and mapped to two mask sets via the layout decomposition step S2, and a layout pattern L1″ that has a decomposed layout is generated. Since the layout decomposition step S2 may result in unresolvable odd cycles (or unresolvable DPT conflict) (that is, sections in two adjacent sub-patterns cannot be decomposed and mapped to different mask sets), the layout decomposition step S2 may result in layout conflicts c1 and c1′ and a pattern stitch st1 of the layout pattern L1″.

As shown in FIG. 1B, the layout decomposition step S1′ is executed ahead of the layout migration step S2′. A layout pattern L2 that has the same layout as the layout pattern L1 is cited as an example. Each sub-pattern 100 of the initial layout pattern L2 on a single mask set is decomposed and mapped to two mask sets via the layout decomposition step S1′, and a layout pattern L2′ that has decomposed layout is generated. Since the layout decomposition step S1′ may result in unresolvable odd cycles, the layout pattern L2′ generated due to the execution of the layout decomposition step S1′ may have a layout conflict c2. Then, the layout migration step S2′ is executed on the layout pattern L2′ to adjust the pitches of the sub-patterns in the layout pattern L2′, and to generate a layout pattern L2″ that conforms with a new manufacturing process. Accordingly, the layout migration step S2′ may result in the difference between the layout patterns L2 and L2″, e.g., different-sized pitches between the sub-patterns.

In comparison with the layout pattern L1″, which is generated by the subsequent execution of the layout migration step S1 and the layout decomposition step S2 and has two layout conflicts c1 and c1′ and one pattern stitch st1, the layout pattern L2″ is generated by the subsequent execution of the layout decomposition step S1′ and the layout migration step S2′ and has one pattern stitch st2 and a larger layout area.

In conclusion, the layout decomposition technology and the layout migration technology currently applied to the integrated circuit layout patterns of the prior art have some drawbacks, whether the layout decomposition step or the layout migration step is executed first.

Since the layout pattern of the prior art cannot be optimized, no matter what step is executed first, how to concurrently process layout migration and layout decomposition of the integrated circuit layout pattern to reduce the layout area and decrease the numbers of the layout conflicts and pattern stitches based on the double patterning technology is becoming one of the most urgent issues in the art.

### SUMMARY OF THE INVENTION

In view of the above-mentioned problems of the prior art, the present invention provides a method for concurrent migration and decomposition of an integrated circuit layout, so as to overcome the drawbacks of the prior art that the layout area is large and too many pattern stitches and layout conflicts are on the layout patterns due to the separate execution of the layout migration and layout decomposition steps to the layout patterns.

The method for concurrent migration and decomposition of integrated circuit layout according to the present invention includes: cutting a sub-pattern of an initial layout pattern in the integrated circuit layout to configure a potentially conflicting pattern having separate or cutting sections; removing odd cycles of the potentially conflicting pattern so as to cut the separate or cutting sections into cut sections; configuring a double patterning constraint based upon corresponding location relations between each and its adjacent ones of the cut sections; and assigning a first color layer or a second color layer to the cut sections according to the double patterning constraint, to obtain a final layout pattern.

Compared with the prior art, the method for concurrent migration and decomposition of the integrated circuit layout according to the present invention overcomes the problems that the subsequent execution of the layout migration and layout decomposition steps result in too many layout conflicts and pattern stitches exist in the layout patterns and that the subsequent execution of the layout decomposition and layout migration steps result in too large the layout area and too many the pattern stitches, by concurrently executing the layout migration and layout decomposition steps. Accordingly, the method for concurrent migration and decomposition of the integrated circuit layout according to the present invention improves the printability of the integrated circuit layout pattern and the reliability of the generated integrated circuit, and overcomes various difficulties encountered in the integrated circuit manufacturing process advanced from the deep sub-micrometer level into nanometer level.

### BRIEF DESCRIPTION OF DRAWINGS

FIGS. 1A and 1B show new layout patterns generated by the execution of layout migration and layout decomposition steps in different orders;

FIGS. 2A to 2F show the execution of sub-pattern corner cutting, potentially conflicting pattern configuring, odd cycle detecting and sub-patterning cutting steps on a layout pattern according to a method for concurrent migration and decomposition of integrated circuit layout of the present invention;

FIG. 3A is a schematic diagram illustrating a method for concurrent migration and decomposition of integrated circuit layout to configure a horizontal double pattern constraint of an embodiment according to the present invention;

FIG. 3B shows the migration and decomposition of layout patterns according to a horizontal double patterning constraint after the horizontal double patterning constraint is configured by the method for concurrent migration and decomposition of integrated circuit layout according to the present invention;

FIG. 4A is a schematic diagram illustrating a method for concurrent migration and decomposition of integrated circuit layout to adjust the pitches between two sections located on different sub-patterns, or to change color layers of specific sections, in consideration of the layout area;

FIG. 4B is a schematic diagram illustrating a method for concurrent migration and decomposition of integrated circuit layout to implement lesser pattern stitches and/or layout area than step S1 followed by step S2 as shown in FIG. 1A and step S1′ followed by step S2′ as shown in FIG. 1B;

FIG. 5 is a schematic diagram illustrating a method for concurrent migration and decomposition of integrated circuit layout to diminish any layout conflict that may appear in a standard cell-based design method, in consideration of double patterning technology effect on the edges of the standard cells; and

FIG. 6 is a flow chart of a method for concurrent migration and decomposition of integrated circuit layout according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

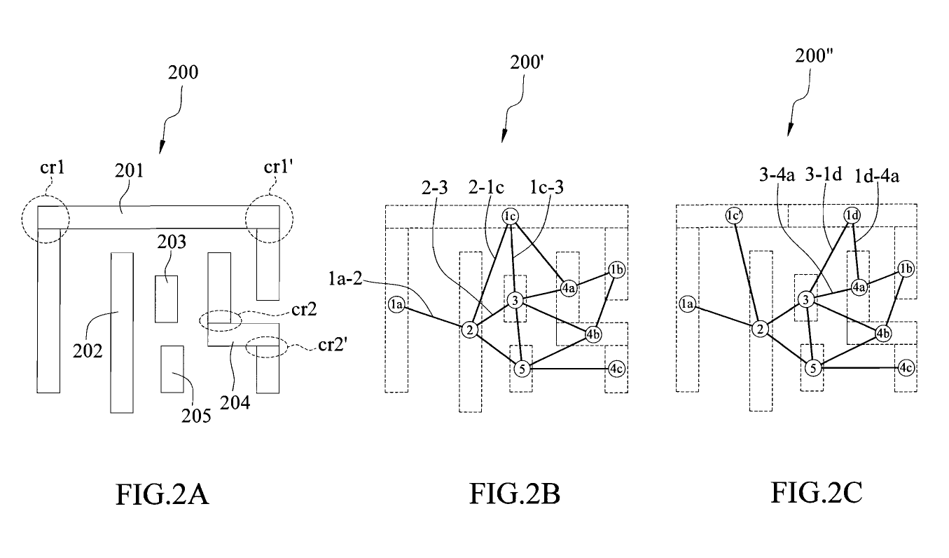

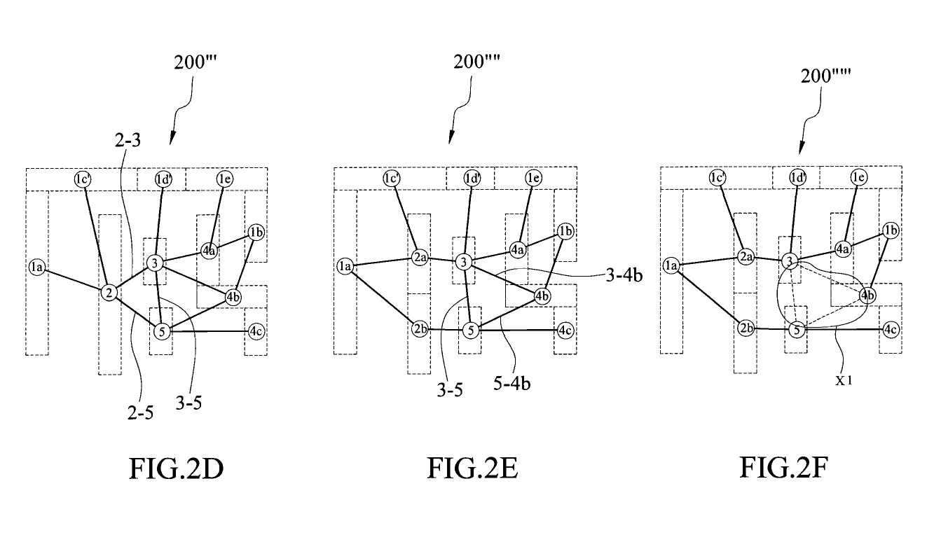

FIGS. 2A to 2F show schematic diagrams of an embodiment that a method for concurrent migration and decomposition of integrated circuit layout according to the present invention cuts sub-pattern corners, configures potentially conflicting patterns, detects odd cycles and cuts sub-patterns.

As shown in FIG. 2A, an initial layout pattern 200 has sub-patterns 201-205. The sub-pattern 201 has two corners cr1 and cr1′. Similarly, the sub-pattern 204 also has two corners cr2 and cr2′. The method for concurrent migration and decomposition of the integrated circuit layout according to the present invention searches the initial layout pattern 200 for any sub-pattern that has at least one corner (e.g., the sub-patterns 201 and 204), cuts the sub-patterns 201 and 204 at the corners cr1, cr1′, cr2 and cr2′ into three cut sections (e.g., cutting sections 1a, 1b, 1c, 4a, 4b and 4c, as shown in FIG. 2B), and deems sub-pattern 202, 203 and 205, all of which do not have any corner, as separate sections 2, 3 and 5, respectively. The cutting sections and separate sections in the sub-patterns hereinafter may either refer to the to-be-cut sections or the cut sections, depending on the contexts.

As shown in FIG. 2B, a potentially conflicting pattern is configured in a layout pattern 200′, and edges between adjacent cutting or separate sections located on different sub-patterns are established. Note that the adjacent sections represent any two adjacent sections between which no other section exists, and that any one of the edges represents a corresponding location relation between two adjacent sections and does not physically make any change or edge on the layout patterns or the sub-patterns. For example, no other section exists between the cutting section 1a and the separate section 2 and the cutting section 1a and the separate section 2 are located on different sub-patterns. Accordingly, an edge 1a-2 is established between the cutting section 1a and the separate section 2. Similarly, an edge 2-3 is established between the separate section 2 and the separate section 3. Therefore, edges may be established, as illustrated in the figure, between adjacent sections located on different sub-patterns in the layout pattern 200′, so as to configure the potentially conflicting pattern.

Note that the potentially conflicting pattern that is configured regarding the initial layout pattern may have an odd cycle, i.e., a cycle with an odd number of edges. Once the layout pattern has any odd cycle, the layout pattern has layout conflicts. For example, as shown in FIG. 2B, edges 2-3, 2-1c and 1c-3 form an odd cycle, which represents that layout conflicts may exist among the separate sections 2 and 3 and the cutting section 1c.

The method for concurrent migration and decomposition of the integrated circuit layout according to the present invention detects odd cycles, by configuring the potentially conflicting pattern, and further removes the odd cycles by the use of suitable sub-pattern cutting.

For example, as shown in FIG. 2C the method for concurrent migration and decomposition of the integrated circuit layout according to the present invention cuts the cutting section 1c shown in FIG. 2B into sub-cutting sections 1c′ and 1d, and establishes edges between adjacent sections located on different sub-patterns in the layout pattern 200″, so as to reconfigure the potentially conflicting pattern. Note that through suitable sub-pattern cutting, the odd cycles may be removed. As shown in FIG. 2C, the separate sections 2 and 3 and the sub-cutting section 1c′ do not have any odd cycle. In other words, the separate sections 2 and 3 and the sub-cutting section 1c′ have no layout conflict.

Similarly, as shown in FIG. 2C edges 3-4a, 3-1d and 1d-4a in the layout pattern 200″ form an odd cycle, which represents that a layout conflict may exist among the separate section 3, the cutting section 4a and the sub-cutting section 1d′. The method for concurrent migration and decomposition of the integrated circuit layout according to the present invention, through the use of suitable sub-pattern cutting, cuts the sub-cutting section 1d shown in FIG. 2C into sub-sub-cutting section 1d′ and sub-sub-cutting section 1e shown in FIG. 2D, and re-establishes edges on adjacent sections located on different sub-patterns in the potentially conflicting pattern 200′″, so as to re-configure the potentially conflicting pattern. It can be understood from the above method that, through the suitable sub-pattern cutting, the odd cycle may be removed. Therefore, the separate section 3, the cutting section 4a and the sub-sub-cutting section 1d′ have no odd cycle. In other words, the separate section 3, the cutting section 4a and the sub-sub-cutting section 1d′ do not have any layout conflict.

As shown in FIG. 2D, edges 2-5, 3-5 and 2-3 in the potentially conflicting pattern 200′″ also form an odd cycle, which represents a layout conflict may exist among the separate sections 2, 3 and 5. The method for concurrent migration and decomposition of integrated circuit layout according to an embodiment of the present invention, through the use of suitable sub-pattern cutting, removes the odd cycle. As shown in FIG. 2E, in the method for concurrent migration and decomposition of the integrated circuit layout according to the present invention the separate section 2 shown in FIG. 2D is cut into a cutting section 2a and a cutting section 2b shown in FIG. 2E, and edges are established among the adjacent sections located on different sub-patterns in the potentially conflicting pattern 200″″, so as to reconfigure the potentially conflicting pattern. As described previously, the odd cycle may be removed through the use of suitable sub-pattern cutting. Therefore, the separate sections 2, 3 and 5, through the use of the cutting way to the separate section 2 shown in FIG. 2D, no longer have any odd cycle.

Note that once an odd cycle that cannot be removed through the suitable sub-pattern cutting during the configuration of the potentially conflicting pattern is found, the odd cycle is referred to as an unresolvable odd cycle, which represents that sections on two adjacent sub-patterns cannot be decomposed and mapped to different color layers (mask sets), without generating a layout conflict.

As shown in FIGS. 2E and 2F, edges 3-5, 3-4b and 5-4b in a potentially conflicting pattern 200″″ also form an odd cycle, which represents that the separate sections 3 and 5 and the cutting section 4b may have a layout conflict. However, the odd cycle cannot be removed through the use of the suitable sub-pattern cutting. As shown in FIG. 2F, the separate sections 3 and 5 and the cutting section 4b cannot be decomposed and mapped to different color layers (mask sets), without generating a layout conflict. Therefore, the odd cycle of the edges 3-5, 3-4b and 5-4b is an unresolvable odd cycle X1.

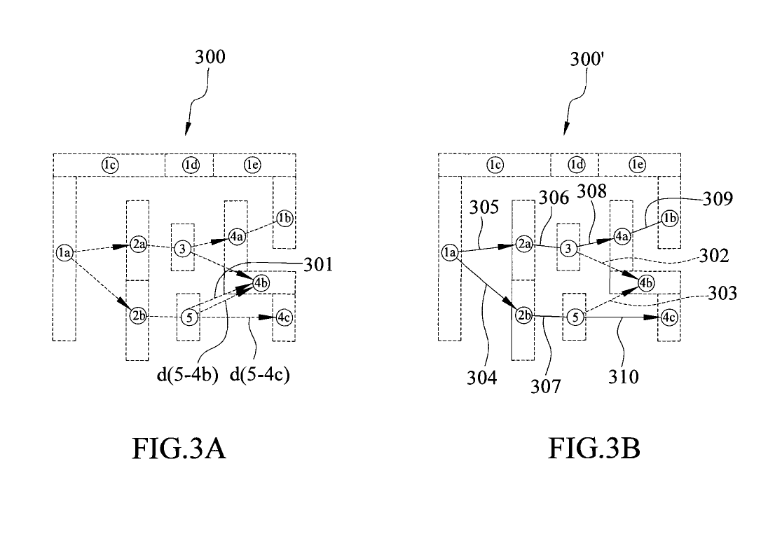

Shown in FIG. 3A is a schematic diagram of a method for concurrent migration and decomposition of the integrated circuit layout to configure a horizontal double patterning constraint of an embodiment according to the present invention. The method for concurrent migration and decomposition of integrated circuit layout according to the present invention considers, according to the potentially conflicting pattern shown in FIG. 2F, horizontal corresponding location relations among each of the cut sections and other sections to configure the horizontal double patterning constraint, and defines all of the edges in the layout pattern 300 that represent corresponding location relations among all sections in the horizontal direction (e.g., edges d(5-4b), d(5-4c)) as the horizontal double patterning constraint. The method also configures a vertical double patterning constraint, by considering the vertical corresponding location relations among each of the sections and other sections and defining edges in the layout pattern that represent corresponding location relations among all of the sections in the vertical direction as the vertical double patterning constraint.

When an edge 301 that represents the corresponding location relation between two sections is neither in the vertical direction nor in the horizontal direction, such as in an obliquely diagonal direction, the edge 301 pertains to any one of the horizontal double patterning constraint and the vertical double patterning constraint.

As shown in FIG. 3B, the method for concurrent migration and decomposition of the integrated circuit layout according to the present invention, after configuring the horizontal double patterning constraint, migrates and decomposes the layout patterns according to the double patterning constraint. For example, when the potentially conflicting pattern does not have any unresolvable odd cycle, the method for concurrent migration and decomposition of the integrated circuit layout according to the present invention assigns all of the sections in the layout patterns to the first color layer that represents the first mask set and the second color layer that represents the second mask set according to the horizontal double patterning constraint and the vertical double patterning constraint, so as to make the sections on two ends of each edge in the potentially conflicting pattern pertain to different color layers, and to make the sections on the same sub-pattern pertain to the same color layer, so as to reduce the number of pattern stitches. However, when the potentially conflicting pattern does have an unresolvable odd cycle, the sections on two ends of each edge of the unresolvable odd cycle are allowed to pertain to different color layers, and the sections on two ends of the remaining edges of the unresolvable odd cycle are assigned to the first color layer and the second color layer, respectively. Therefore, the sections on two ends of each edge pertain to different color layers, while the sections on the same sub-pattern pertain to the same color layer.

Further, the method for concurrent migration and decomposition of the integrated circuit layout according to the present invention, after configuring the horizontal double patterning constraint, can also adjust the distance between the sections on two ends of all edges in the horizontal double patterning constraint. For example, when the cut sections on two ends of each edge in the horizontal double patterning constraint pertain to different color layers, the distance between the cut sections is adjusted to be a minimum cell pitch defined by the integrated circuit manufacturing process. On the other hand, when the sections on two ends of each edge in the horizontal double patterning constraint pertain to the same color layer, the distance between the sections is adjusted to be twice the minimum cell pitch defined by the integrated circuit manufacturing process.

Similarly, the method for concurrent migration and decomposition of the integrated circuit layout according to the present invention, after configuring the vertical double patterning constraint, can also adjust the distance between the sections on two ends of all edges in the vertical double patterning constraint. For example, when the sections on two ends of each edge in the vertical double patterning constraint pertain to different color layers, the distance between the sections is adjusted to be a minimum cell pitch defined by the integrated circuit manufacturing process. On the contrary, when the sections on two ends of each edge in the vertical double patterning constraint pertain to the same color layer, the distance between the sections is adjusted to be twice the minimum cell pitch defined by the integrated circuit manufacturing process.

Note that the corresponding location relations among the sections on the same sub-pattern are fixed, and cannot be adjusted according to the horizontal double patterning constraint and vertical double patterning constraint.

As shown in the drawings, since the potentially conflicting pattern of the layout pattern 300′ has unresolvable odd cycles, edges 302 and 303 of the horizontal double patterning constraint of the layout pattern 300′ are called DPT edges. The DPT edges 302 and 303 may adjust the pitch between the separate section 5 and the cutting section 4b and/or adjust the pitch between the separate section 3 and the cutting section 4b according to the integrated circuit manufacturing process. Sections on two ends of the DPT edges 302 and 303 may pertain to the same color layer, and the pitch between the sections is twice the minimum cell pitch defined by the integrated circuit manufacturing process. In other words, the DPT edges 302 and 303 represent that the sections on two ends may have layout conflicts. Through suitable adjustment to the pitch between the separate section 5 and the cutting section 4b and/or to the pitch between the separate section 3 and the cutting section 4b according to the integrated circuit manufacturing process, the layout conflicts may be avoided.

As shown in the drawings, edges 304-310 of the horizontal double patterning constraint of the layout pattern 300′ are called ordinary edges. The so-called ordinary edges mean that the sections on two ends of each of the edges pertain to different color layers, and the pitch between the sections is the minimum cell pitch defined by the integrated circuit manufacturing process.

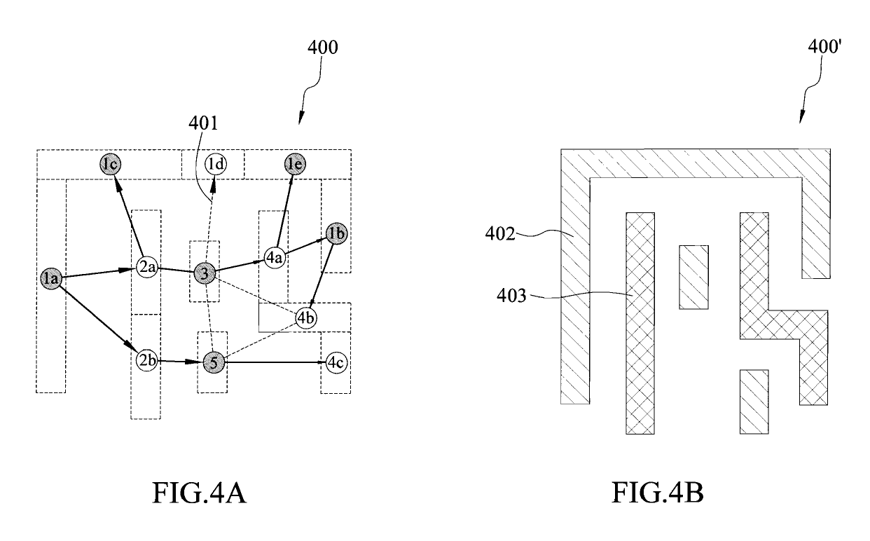

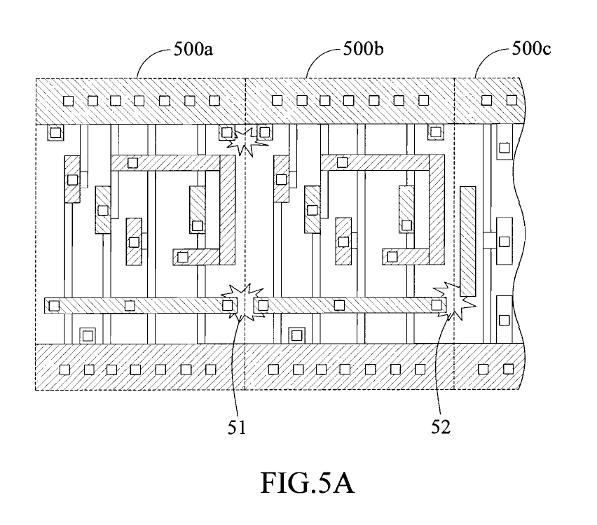

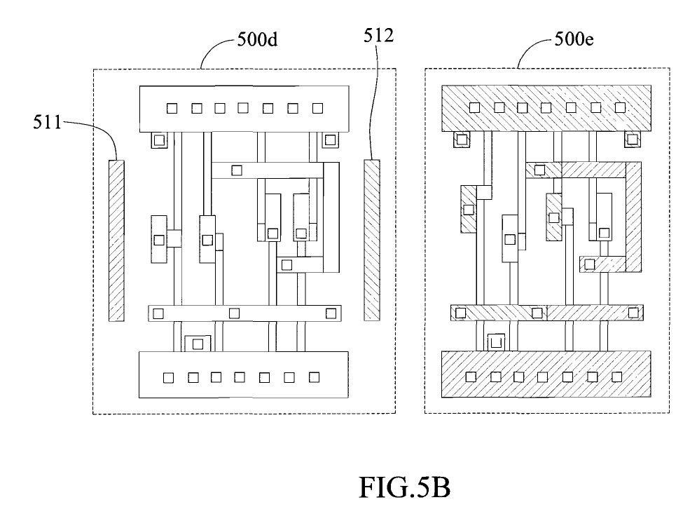

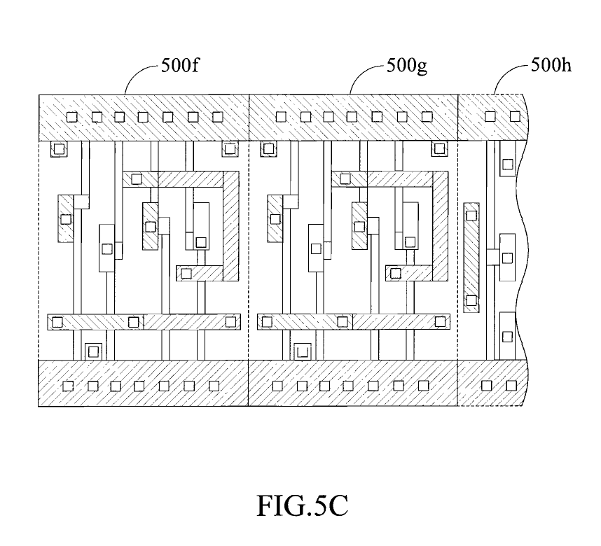

The method for concurrent migration and decomposition of the integrated circuit layout according to the present invention involves selecting one of a plurality of layout migration and layout decomposition strategies according to the double patterning constraint, based on the demands or manufacturing strategies of different products, to find out the integrated circuit layout that occupies the least layout area. As shown in FIG. 4A, a schematic diagram shows the method for concurrent migration and decomposition of the integrated circuit layout to adjust the pitch between two sections on different sub-patterns based on various demands or change the color layer of certain section in consideration of layout area. In detail, the separate section 3 and the sub-cutting section 1d on two ends of an edge 401 of a layout pattern 400 are assigned to different color layers (the circles shown in FIG. 4A and filled with white or gray-leveled color represent different color layers). Accordingly, the pitch between the separate section 3 and the sub-cutting section 1d can be reduced to be the minimum cell pitch defined by the integrated circuit manufacturing process. However, the sub-cutting section 1d and the adjacent sub-cutting section 1c and the sub-sub-cutting section 1e on the same sub-pattern pertain to different color layers. Therefore, two pattern stitches are added in the layout pattern 400, and the reliability and printability of the manufacturing process are thus reduced.

On the contrary, in another embodiment of the present invention, the separate section 3 and the sub-cutting section 1d on two ends of the edge 401 in the layout pattern 400 may be assigned to the same color layer (not shown). Accordingly, the pitch between the separate section 3 and the sub-cutting section 1d has to be augmented to twice the minimum cell pitch defined by the integrated circuit manufacturing process, such that the layout area necessary for the layout pattern 400 increases. However, the sub-cutting section 1d and the adjacent sub-cutting section 1c and the sub-sub-cutting section 1e located on the same sub-pattern pertain to the same color layer. Therefore, no pattern stitch exists in the layout pattern 400, and the reliability and printability of the manufacturing process are improved. In other words, the method for concurrent migration and decomposition of the integrated circuit layout according to the present invention may select one of a plurality of layout migration and layout decomposition strategies according to the double patterning constraint, based on the demands or manufacturing strategy of different products, to find out the integrated circuit layout that has the least pattern stitches.

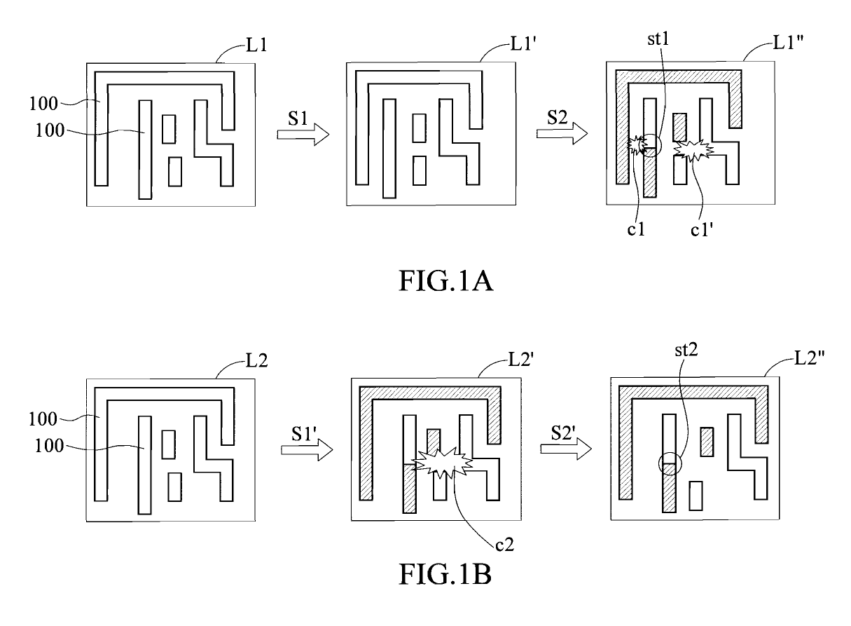

Referring to FIG. 4B, a schematic diagram illustrating a method for concurrent migration and decomposition of integrated circuit layout to implement lesser pattern stitches and/or layout area than step S1 followed by step S2 in FIG. 1A and step S1′ followed by step S2′ in FIG. 1B is shown. As shown in the drawing, a layout pattern 400′ has less pattern stitches than the layout pattern L1″ shown in FIG. 1A and is free of a potentially conflicting pattern. On the other hand, the layout pattern 400′ has less layout area and pattern stitches than the layout pattern L2″ shown in FIG. 1B and is free of a potentially conflicting pattern. Sub-patterns 402, 403 of the layout pattern 400′ are attributed to different mask sets, respectively.

In the integrated circuit design, a standard cell-based design method is one of the most popular and rapid design ways in the digital circuit designing art. The standard cell-based design method allows a user to focus on higher-level design issues and save the cost and time in designing circuit cells. Besides, since the standard cells are arranged in a row, and a power contact layer and a ground contact layer are aligned to each other, the DPT effect of the vertical standard cells has to be taken into account. The method for concurrent migration and decomposition of the integrated circuit layout according to the present invention also provides a couple of embodiments that can be applied to the standard cell-based design method.

FIGS. 5A-5C are schematic diagrams of a method for concurrent migration and decomposition of the integrated circuit layout according to the present invention applied to a standard cell-based design method, in consideration of the DPT effect on the edges of the standard cells, to diminish the potential layout conflicts. As shown in FIG. 5A, without considering the DPT effect on edges of the standard cells, exactly the same standard cells 500a, 500b and 500c are put together to generate layout conflicts (as designated by numerals “51” and “52”). Therefore, as shown in FIG. 5B, considering the DPT effect on the edges of the standard cells, pseudo patterns 511 and 512 are placed on the edges of the standard cell 500d, such that no layout conflict exists when the standard cells 500d and 500e are placed together. The pseudo patterns 511 and 512 are placed on the edges of the standard cell 500d according to the pitch defined by the integrated circuit manufacturing process. Accordingly, as shown in FIG. 5C, the standard cells 500f, 500g and 500h that are pus together do not have any layout conflict.

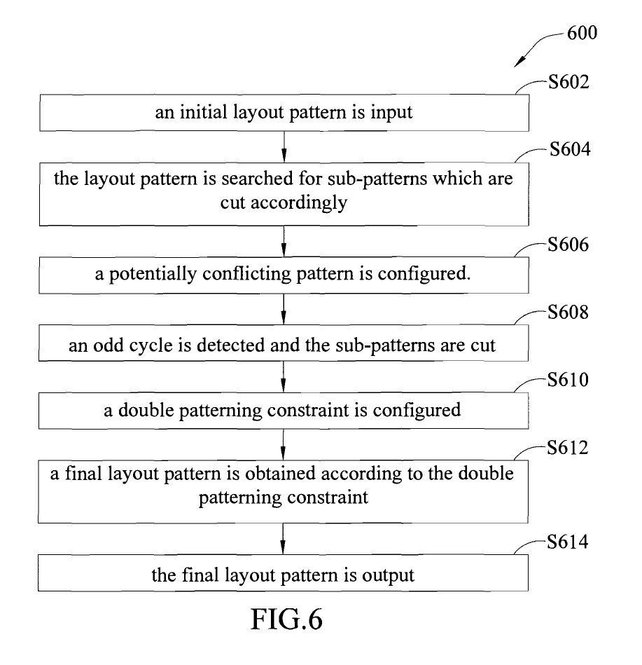

Shown in FIG. 6 is a flow chart of a method for concurrent migration and decomposition of the integrated circuit layout according to the present invention. The method starts in step S602. In step S602, an initial layout pattern is input. Proceed to step S604. In step S604, the layout pattern is searched for all sub-patterns that have at least one corner, the found sub-patterns are cut into a plurality of corresponding cut sections at the corners of the sub-patterns, and the remaining sub-pattern without any corner are deemed as separate sections. Proceed to step S606.

In step S606, a potentially conflicting pattern is configured, and an edge between adjacent sections on different sub-patterns is established, wherein the adjacent sections represent two section between which no other section exists, and the edge represents the corresponding location relation between the sections, rather than any physical change or edge performed on the layout pattern or the sub-patterns. Proceed to step S608.

In step S608, an odd cycle is detected and the sub-patterns are cut. When some edges in the layout pattern are to be formed with a multi-edge cycle having an odd number of edges, one of an odd number of sections of the multi-edge cycle is cut into a plurality of sub-cutting sections, and new edges are formed among the sub-cutting sections and the uncut sections in the odd number of sections. Therefore, the multi-edge cycle may be removed. When the multi-edge cycle cannot be removed, the multi-edge cycle is defined to be an unresolvable odd cycle. Proceed to step S610.

In step S610, a double patterning constraint is configured, in which edges in the layout pattern that represent the corresponding location relations among all sections in the horizontal direction are defined as a horizontal double patterning constraint, edges in the layout pattern that represent the corresponding location relations among all sections in the vertical direction are defined as a vertical double patterning constraint, and edges that represent a corresponding location relation between two sections are defined as one of the horizontal double patterning constraint and the vertical double patterning constraint if the edges are neither in the horizontal direction nor in the vertical direction. Proceed to step S612.

In step S612, sections cut are assigned to be the first color layer or the second color layer according to the double patterning constraint, to obtain the final layout pattern, and find out an integrated circuit layout that has the least pattern stitches and/or the smallest layout area, depending on the various product demands or manufacturing process strategies. Proceed to step S614. In step S614, the final layout pattern is output.

Compared with the prior art, the method for concurrent migration and decomposition of the integrated circuit layout according to the present invention greatly improves the elasticity and efficiency of the integrated circuit layout, and significantly reduces the number of potential layout conflicts and pattern stitches through concurrent migration and decomposition of the integrated circuit layout. Moreover, the method for concurrent migration and decomposition of the integrated circuit layout according to the present invention also overcome the problem that the layout migration and layout decomposition need a large layout area. Further, the method for concurrent migration and decomposition of the integrated circuit layout according to the present invention performs layout migration and layout decomposition according to the a double patterning constraint, based on the various product demands and manufacturing process strategies, to find out an integrated circuit layout that has the least pattern stitches and/or the smallest layout area.

The foregoing descriptions of the specific embodiments are intended to illustrate and disclose the features and functions of the present invention and are not restrictive of the scope of the present invention. It should be understood to those in the art that all modifications and variations according to the spirit and principle in the disclosure of the present invention should fall within the scope of the appended claims.

What is claimed is:

1. A method for concurrent migration and decomposition of an integrated circuit layout, comprising the steps of:
cutting a sub-pattern of an initial layout pattern in the integrated circuit layout to configure a potentially conflicting pattern having separate or cutting sections;
removing odd cycles of the potentially conflicting pattern so as to cut the separate or cutting sections into cut sections;
configuring a double patterning constraint based upon corresponding location relations between each and its adjacent ones of the cut sections; and
assigning a first color layer or a second color layer to the cut sections according to the double patterning constraint, to obtain a final layout pattern.

2. The method of claim 1, wherein the step of cutting a sub-pattern of an initial layout pattern comprises searching the initial layout pattern for all sub-patterns having at least one corner so as to cut the sub-patterns at the at least one corner to form the cutting sections.

3. The method of claim 1, wherein the separate sections are sub-patterns without any corners.

4. The method of claim 1, wherein the step of configuring a potentially conflicting pattern having separate or cutting sections comprises establishing edges between adjacent separate or cutting sections disposed on different sub-patterns.

5. The method of claim 4, wherein no section exists between the adjacent separate or cutting sections.

6. The method of claim 4, wherein the edges between the adjacent separate or cutting sections represent a corresponding location relation between the adjacent separate or cutting sections.

7. The method of claim 1, wherein the step of removing odd cycles of the potentially conflicting pattern so as to cut the separate or cutting sections is to cut at least one of an odd number of separate or cutting sections that have a multi-edge cycle having an odd number of edges into at least one section, and to establish an edge between the at least one section and uncut sections among the odd number of separate or cutting sections, so as to remove the multi-edge cycle having the odd number of edges.

8. The method of claim 1, wherein the step of removing odd cycles of the potentially conflicting pattern so as to cut the separate or cutting sections is to define a multi-edge cycle that has an odd number of edges and cannot be removed as an unresolvable odd cycle when the multi-edge cycle exists in the potentially conflicting pattern.

9. The method of claim 1, wherein the step of configuring a double patterning constraint comprises:
configuring a horizontal double patterning constraint by defining edges in the layout pattern that represent corresponding location relations among all of the separate or cutting sections in a horizontal direction as the horizontal double patterning constraint; and
configuring a vertical double patterning constraint by defining edges in the layout pattern that represent corresponding location relations among all of the separate or cutting sections in a vertical direction as the vertical double patterning constraint.

10. The method of claim 9, wherein if an edge that represents a corresponding location relation between two sections is neither in the horizontal direction nor in the vertical direction, the edge is defined as pertaining to one of the horizontal double patterning constraint and the vertical double patterning constraint.

11. The method of claim 9, wherein the step of assigning a first color layer or a second color layer to the cut sections according to the double patterning constraint is to assign each of the cut sections to the first color or the second color layer according to the horizontal double patterning constraint and the vertical double patterning constraint, when no unresolvable odd cycle exists in the potentially conflicting pattern, and to make each of the cut sections on two ends of each of the edges pertain to different color layers and the cut sections located on the same sub-pattern pertain to the same color layer.

12. The method of claim 9, wherein the step of assigning a first color layer or a second color layer to the cut sections according to the double patterning constraint is to assign each of the cut sections on two ends of each edge of an unresolvable odd cycle to different color layers and the cut sections on two ends of all edges except the unresolvable odd cycle to the first color layer and the second color layer respectively, when the unresolvable odd cycle exists in the potentially conflicting pattern, to assign the cut sections on two ends of each of the edges to different color layers, and to make the cut sections located on the same sub-pattern pertain to the same color layer.

13. The method of claim 12, wherein the step of assigning a first color layer or a second color layer to the cut sections according to the double patterning constraint further comprises:
adjusting a distance between each of the cut sections on two ends of all the edges in the horizontal double patterning constraint, and when the cut sections on two ends of each of the edges in the horizontal double patterning constraint pertain to different color layers, adjusting a distance of the sections to be a minimum cell pitch defined by an integrated circuit manufacturing process.

14. The method of claim 13, wherein the step of assigning a first color layer or a second color layer to the cut sections according to the double patterning constraint further comprises:
adjusting the distance between the sections to be twice the minimum cell pitch defined by the integrated circuit manufacturing process, when the cut sections on two ends of each of the edges in the horizontal double patterning constraint pertain to the same color layer.

15. The method of claim 12, wherein the step of assigning a first color layer or a second color layer to the cut sections according to the double patterning constraint further comprises:
adjusting a distance between sections on two ends of all the edges in the vertical double patterning constraint, and when the cut sections on two ends of each of the edges in the vertical double patterning constraint pertain to different color layers, adjusting a distance of the section to be a minimum cell pitch defined by an integrated circuit manufacturing process.

16. The method of claim 15, wherein the step of assigning a first color layer or a second color layer to the cut sections according to the double patterning constraint further comprises:
adjusting the distance between the sections to be twice the minimum cell pitch defined by the integrated circuit manufacturing process, when the cut sections on two ends of each of the edges in the vertical double patterning constraint pertain to the same color layer.
